(19) United States
(12) Patent Application Publication
(10) Pub. No.: US 2023/0211733 A1
(43) Pub. Date: Jul. 6, 2023

(54) Add-On Alert Display For A Vehicle

(71) Applicant: RIDE VISION LTD., Herzliya (IL)

(72) Inventors: Uri LAVI, Netanya (IL); Lior COHEN, Hod Hasharon (IL); Moshe ELIYAHU, Tel Aviv (IL); Ilan HAZI, Rosh Haayin (IL)

(21) Appl. No.: 17/998,930

(22) PCT Filed: Apr. 7, 2021
(86) PCT No.: PCT/IL2021/050394

§ 371 Date: Nov. 16, 2022

Related U.S. Application Data
(60) Provisional application No. 63/030,443, filed on May 27, 2020.
(60) Provisional application No. 63/091,383, filed on Oct. 14, 2020.

(51) Int. Cl. B60R 1/12; B60K 35/00

(52) U.S. Cl. CPC B60R 1/12; B60K 35/00; B60K 2370/152; B60K 2370/332; B60K 2370/691; B60R 2001/1215

(57) ABSTRACT

The invention relates to an add-on display configured for attachment to a contour frame of a side-mirror of a vehicle and to provide visual awareness, safety or alert signals, comprising at least partially flexible casing, said casing comprising: (a) a partition wall separating between a front portion and a rear portion of the casing; (b) said front portion comprising one or more sections along a longitudinal axis of the casing, at least one of the sections is configured to contain at least one Light Emitting Diodes (LEDs) that issues said visual signals; (c) a connecting piece in between any two adjacent sections, if more than one exists, said connecting piece comprising at least a first opening at its bottom; and (d) at least one attachment surface configured for attachment to a surface of said contour frame the side-mirror of the vehicle.

### FIELD OF THE INVENTION

The invention generally relates to a vehicle’s safety systems and accessories. More particularly, the invention relates to an add-on driver’s awareness, safety, or alert display, for attachment to a vehicle’s mirror.

### BACKGROUND OF THE INVENTION

In the recent decade, ADAS (Advanced Driver Assistance Systems) have become standard in most newly manufactured four-wheel vehicles traveling on public roads. ADAS provides various alerts to the driver, such as a possible collision, an unsafe distance from a vehicle ahead, a general obstacle ahead, notice about a side obstacle, exceeding the speed limit, and even rear-view obstacles during parking. Typically, the ADAS applies one or more of the following sensors: camera, radar, or laser to acquire data from the vehicle’s surroundings. A processor that is a part of the ADAS analyses the data and issues an alert any time when a danger that exceeds a predefined threshold is detected. While ADAS has been traditionally referred to alerts and assistance signals relating to the actual driving functionality, additional signals can still be obtained from external sources and delivered to the driver (or rider) over the ADAS platform. In this application, ADAS is broadly referred to any type of alert (or signal), whether relating to the driving functionality or any other warning (such as “accident ahead”, “traffic jam ahead”, etc., as obtained from external or internal sources), delivered to a rider.

While the ADAS has become standard in all new four-wheel vehicles, the motorcycle industry remained somewhat behind, mainly due to technological, technical, and cost considerations.

The rider’s environment in a two-wheel (or in some cases three-wheel vehicles, hereinafter, the description refers to both said cases equivalently) is significantly harsher than a driver’s environment in a four-wheel vehicle, complicating the capability to convey situational and awareness signals to the rider efficiently. While in a four-wheel vehicle, an ADAS display can be mounted on top of a dashboard, it is not practical to mount an ADAS display on a so-called “dashboard” of a two-wheel vehicle without harming the rider’s attention from the road. Moreover, a rider in a two-wheel vehicle is exposed to high-volume noises from winds, surrounding sounds, and vehicle-engines, while still being required to maintain awareness, even higher than needed for a driver of a four-wheel vehicle.

Given the above limitations in a two-wheel vehicle, some prior art ADAS systems provide awareness and alert signals in a sound form via earphones mounted at the driver’s helmet; The ADAS sound alerts are conveyed to the rider over the same platform that provides to the rider media and communication capabilities. However, mixing the safety alert signals in audio (sound) on the same media and communication platform is not intuitive, may confuse the rider, and cause him to ignore them.

Pending application PCT/IL2019/050634 by the same applicant discloses an ADAS system for a two-wheel driver. Among other aspects, PCT/IL2019/050634 suggests providing visual awareness and alert signals on top of the motorcycle’s one or two mirrors. PCT/IL2019/050634 remained short of showing how an add-on display can be safely attached to the mirror or how a single-size single-shape display can be adapted to mirrors having various dimensions and shapes.

The provision of an add-on display that is attached to a mirror of a two-wheel vehicle remains a challenge. First, the installation must sustain significant forces and vibrations given the winds, accelerations, various road surfaces, etc. Also, existing motorcycles’ mirrors have different shapes and dimensions, and a single structure that fits all or most of such mirrors does not exist. Finally, any ADAS must provide a good, reliable, and intuitive presentation to the rider to ensure safety. Such requirements have not been met by the prior art yet.

It is an object of the present invention to provide an add-on ADAS display for a two-wheel vehicle.

Another object of the present invention is to provide an add-on ADAS display adaptable for installing at an existing mirror of a two-wheel vehicle.

Another object of the present invention is to provide a structure for an add-on ADAS display adaptable for various shapes and dimensions of mirrors existing in the two-wheel vehicles’ market.

Another object of the present invention is to provide an add-on ADAS display for a two-wheel vehicle that is simple in structure and installation and affordable.

Other objects and advantages of the invention become apparent as the description proceeds.

### SUMMARY OF THE INVENTION

The invention relates to an add-on display configured for attachment to a contour frame of a side-mirror of a vehicle and to provide visual awareness, safety or alert signals, comprising at least partially flexible casing, said casing comprising: (a) a partition wall separating between a front portion and a rear portion of the casing; (b) said front portion comprising one or more sections along a longitudinal axis of the casing, at least one of the sections is configured to contain at least one Light Emitting Diodes (LEDs) that issues said visual signals; (c) a connecting piece in between any two adjacent sections, if more than one exists, said connecting piece comprising at least a first opening at its bottom; and (d) at least one attachment surface configured for attachment to a surface of said contour frame the side-mirror of the vehicle.

In an embodiment of the invention, said first opening has an upside-down V-shape in cross-section;

In an embodiment of the invention, each said attachment surface is longitudinally disposed at the rear portion and faces down.

In an embodiment of the invention, each said attachment surface facing down is located at a top protrusion verticcally protruding from said partition wall.

In an embodiment of the invention, the add-on display comprising one or more recesses at each said attachment surfaces, each recess being defined by a respective upper surface, and two side-protrusions.

In an embodiment of the invention, each of said recesses is configured to contain a two-side adhesive layer.

In an embodiment of the invention, said flexible casing is formed as one integral unit.

In an embodiment of the invention, a multi-section container is defined at said front portion by said partition wall and a peripheral extension protruding therefrom.

In an embodiment of the invention, at least one of said Light Emitting Diodes are positioned on a printed board which is configured to issue each said visual signals based on a respectively received external signal.

In an embodiment of the invention, a sequence of Light Emitting Diodes (LEDs) is positioned on each said printed board.

In an embodiment of the invention, each printed board is a rigid-type board.

In an embodiment of the invention, said casing is made of a flexible silicon.

In an embodiment of the invention, the add-on display further comprising a second opening at said connecting piece, said second opening is configured to allow passage of a signal cable.

In an embodiment of the invention, the add-on display further comprising a guiding element configured for attaching said signal cable to a rear or rear-top surface of the side-mirror.

In an embodiment of the invention, said guiding element is further configured to divert the direction of said signal cable.

In an embodiment of the invention, the add-on display further comprising one or more longitudinal bottom protrusions at said rear portion, each said bottom protrusion protrudes from said partition wall a width which is smaller than the width of said top protrision.

In an embodiment of the invention, the add-on display further comprising a transparent window for sealing said multi-section container.

In an embodiment of the invention, an outline of a top wall of the connecting piece is bended-down at an angle with respect to an outline of a top wall of a first of said sections, and an outline of a top wall of a second of said sections is further bended-down at an angle with respect to the outline of said top wall of the connecting piece.

In an embodiment of the invention, each of said bending-down angles is in the order of 10°-15°.

In an embodiment of the invention, the add-on display further comprising one or more bottom elastic elements that are at least partially protrude outwards through the partition wall, and are configured to provide front attachment of the display to a bottom edge of the frame of the side-mirror of the vehicle.

In an embodiment of the invention, each of the bottom elastic elements has a shape of an elastic bended strip.

In an embodiment of the invention, a first section of each elastic element protruds outwards through a respective opening at the partition wall, and a second section of each said elastic element is contained within the front portion of the display.

In an embodiment of the invention, a third section of each of said elastic elements is containd at a cavity within a top protrusion verticcally protruding from said partition wall.

### BRIEF DESCRIPTION OF THE DRAWINGS

In the drawings:

FIG. 1 shows a general front view of an add-on display for attachment to a side-mirror of a two-wheel vehicle, according to an embodiment of the invention;

FIG. 2 shows a two-displays set for attachment to two respective mirrors of a two-wheel vehicle;

FIG. 3 shows a display which is attached to a left-side mirror of a two-wheel vehicle, according to an embodiment of the invention;

FIG. 4 shows a right-display in perspective view, according to an embodiment of the invention;

FIG. 5 shows the casing of the display in a front-perspective view, according to an embodiment of the invention;

FIGS. 6 and 7 show the casing of the display in rear-perspective views, according to an embodiment of the invention;

FIG. 8 shows in exploded view the basic components of a left display, according to an embodiment of the invention; and

FIGS. 9a-9d show an additional embodiment of the display of the invention; FIG. 9a shows a rear view of the display; FIG. 9b shows a plurality of flexible elements that are used for better attachment to the frame of the motorcycle’s mirror; FIG. 9c shows the casing of the display, alone; and FIG. 9d shows a front view of the casing while including three flexible elements for better attachment.

### DETAILED DESCRIPTION OF PREFERRED EMBODIMENTS

The invention provides a structure for an add-on ADAS display suitable for installation on a contour of a side mirror of a two-wheel vehicle. The add-on display structure of the invention is adaptable to various shapes and dimensions of mirrors, thereby substantially eliminating the necessity to produce a specific add-on structure for each particular mirror model, shape, and dimensions. While the examples given herein relate to a two-wheel vehicle, the structure of the display of the invention can fit mirrors of other types of vehicles.

The add-on display of the invention is designed to provide visual awareness, safety, or alert signals. It is configured for attachment on a contour of a side-mirror of a vehicle. In one embodiment, the display includes an at least partially flexible casing. which in turn comprises: (i) a front portion with one or more sections along a longitudinal axis of the casing, each section is designed to contain at least one electronic component, such as light emitting diode; (ii) a connecting piece in between any two adjacent sections, if more than one exists, wherein the connecting piece has at least a first opening at its bottom; and (iii) at least one attachment surface which is configured for attachment to a contour-surface of the frame of a side-mirror of the vehicle; Electronic components, possibly rigid ones (such as printed boards, LED-type lights, etc.), are contained within the sections, while their rigidity does not reduce the flexibility of adaptation of the display to the contour of the mirror’s frame. In one embodiment, the attachment surface is a surface facing down at a top protrusion from a partition wall of the casing. In another embodiment, the attachment surface is one or more external surfaces at one or more bottom walls of the casing. In still another embodiment, the attachment surface is one or more external surfaces on one or more top walls of the casing. As said, more than one attachment surface may be provided at one or more of the casing locations above.

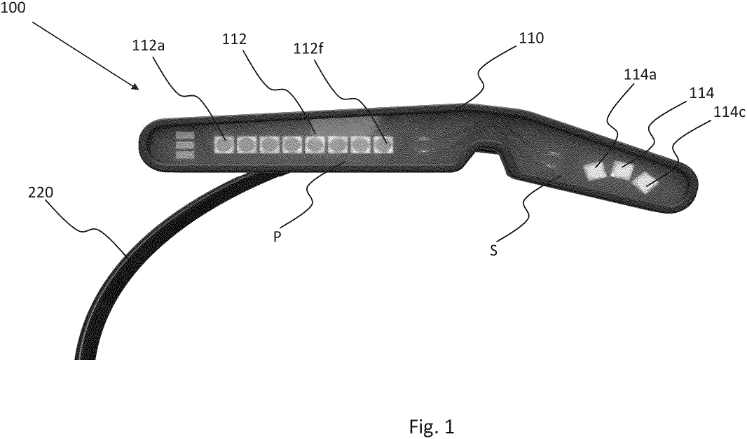

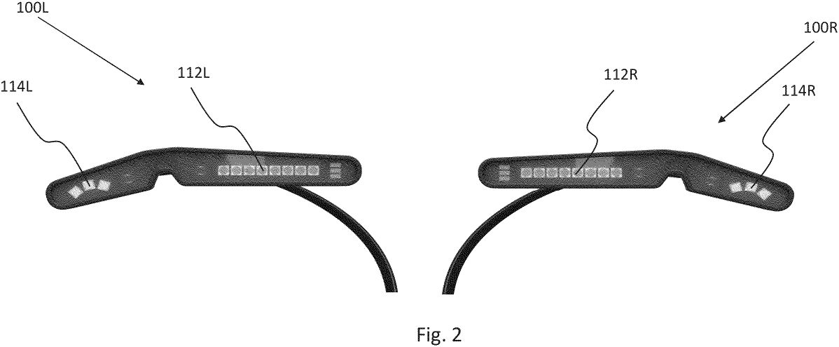

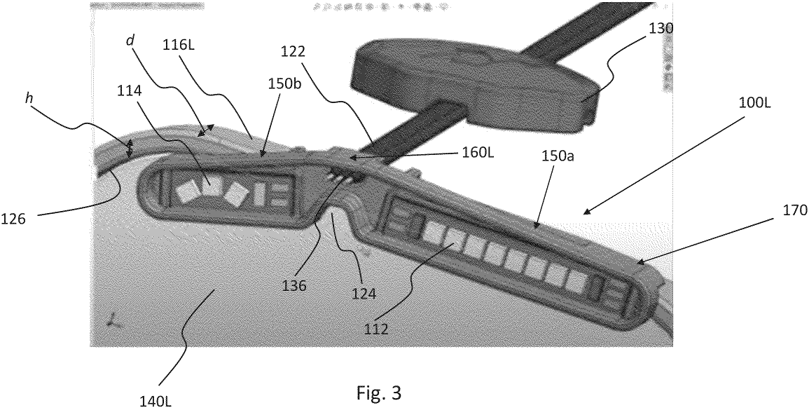

FIG. 1 shows a general view of an add-on display 100 for installation on a mirror of a two-wheel vehicle, according to an embodiment of the invention. FIG. 2 shows a set of two displays: a left-side display 100L for installation on a left mirror of the two-wheel vehicle and a right-side display 100R for installation on the vehicle’s right mirror. FIG. 3 shows a display 100L attached to a left-side mirror 140L of the two-wheel vehicle. When the display 100L is fully installed, both sections 150a and 150b of the add-on display 100L (FIG. 3) are fully attached to the top frame 116L of the mirror. In FIG. 3, however, the left section 150b of the display is depicted, for better illustration somewhat separated from the mirror’s frame 116L. Typical mirrors’ frames have a depth d in the order between 5-15 mm, and a height h also in the order of 4-10 mm (FIG. 3). The display casing of the invention is adapted for attachment to a variety of frames in these dimension ranges, while occupying a negligible hight (in the order of less than 1%) from the effective active area of the side-mirror.

As in a typical ADAS, the alert system includes one or more components that are not a part of the present invention, such as: (a) sensing set comprising or more of cameras, radar, and/or laser; and (b) a processing unit that receives data from the sensing set and issues visual alerts displayed on one or more of the displays 100L and 100R. The visual alerts are conveyed to the display 100 vial cable 122.

Each of the left-side and right-side displays may include two sequences of lights: a red-lights sequence 112 for displaying front-danger alerts (or any other type of alert) and a yellow-lights sequence 114 for displaying rear-danger alerts (or any different kind of warning). Any other color may be used. A non-limiting example illustrating the operation of the displays is as follows (see FIG. 2): (i) if the processing unit detects a potential collision with a front vehicle, in a manner that may result in an accident, both red sequences 112L and 112R simultaneously blink (or turn on/off or emit lights in any other pattern); (ii) If a left-front danger is detected, only the left sequence 112L blinks (or turns on/off or emit light in any other pattern), and similarly, if a rightfront danger is detected, only the right sequence 112R blinks (or turns on/off or emits light in any other pattern); and (iii) If danger approaches from the rear-left, the left sequence 114L blinks (or turns on/off or emits light in any other pattern), and similarly, if danger approaches from the rear-right, the right sequence 114R blinks (or turns on/off or emits light in any other pattern). Additional types of alerts may be defined.

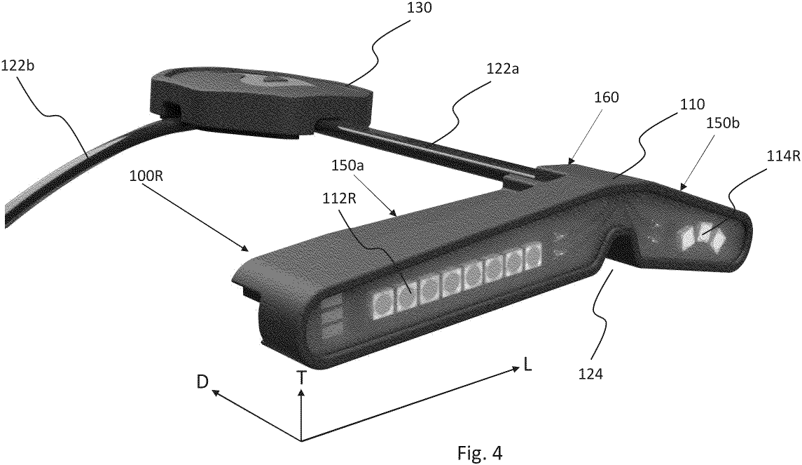

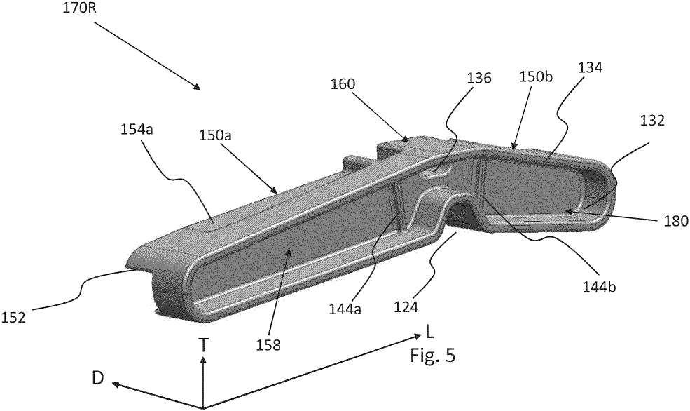

FIG. 4 shows the right display 100R in perspective view. Three axes are defined herein for the sake of explanation, as follow: A longitudinal axis L, a transverse axis T, and a depth axis D. Furthermore, the side of the display which is visible to the rider will be referred to herein as the “front” side (or portion) of the display, while the side opposite to the front side (namely, the side which is typically hidden to the rider) will be referred to as the rear side (or portion) of the display. As will be discussed in more detail hereinafter, the display 100 includes one or more sections. In this embodiment, display 100 includes two sections 150a and 150b, along the longitudinal axis L. Each section is designed to contain another sequence of lights (typically of LED-type), or any other electronics or display elements. A connecting piece 160 is provided in between any two sections 150 and is substantially limited by border-lines 144a and 144b (FIG. 5). The connecting piece includes one or two openings. A first opening 124 at the bottom of the connecting piece has substantially an upside-down V-shape in cross-section (shapes other than upside-down V-shape may also be used, such as, U-shape, or open-bracket shape). The first opening may, in some cases, be blocked by a thin membrane while functioning the same. As will be discussed further hereinafter, the first opening 124 (FIG. 5) allows easy adaptation of the display to different contours of a mirror frame 116 (see FIG. 3). An optional second opening 136 (shown in FIGS. 3, 5, and 7) is located at the top of connecting piece 160 (FIG. 4). It has a shape that substantially conforms to a cross-section of signal cable 122 that conveys signals to the light sequences 112 and 114 and power or any other type of electronic signal. The second opening 136 (FIG. 5) is optional in one or more of the connecting pieces, as one such opening per a display 100 typically suffices (mainly in cases where more than one connecting piece exists in a single display). To allow even easier adaptation of the display to the contour of typical mirror frames 116 (FIG. 3) , the top wall of the connecting piece 160 is somewhat bent down at some angle (for example, at an angle of 10°-15°) relative to the outline of the top wall of section 150a, and the outline of the top wall of the second section 150 is further bent down at an angle (for example, 10°-15°) relative to the outline of the top wall of the connecting piece 160. This configuration reduces the necessity for significant bending during installation.

As also shown in FIG. 4, the signal cable 122 passes through guiding element 130, which is used to grip the cable, and optionally also to divert the cable’s direction (in this specific example by 90°). The guiding element 130 is typically adhesively attached to the rear (or rear-top in some mirror-types) wall of mirror 140 (FIG. 3). It also assists in securing the cable 122 and maintaining the display 100 in its place.

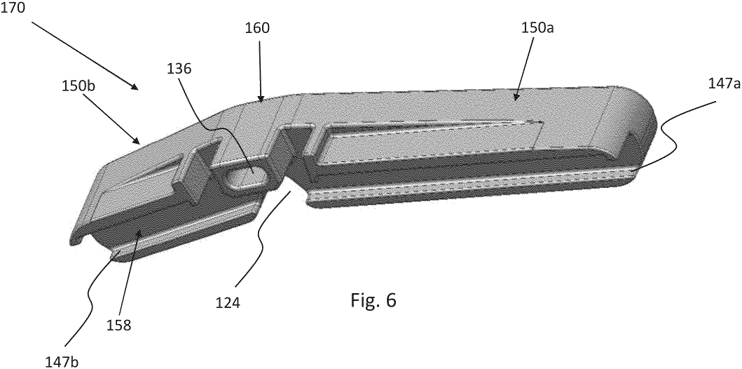

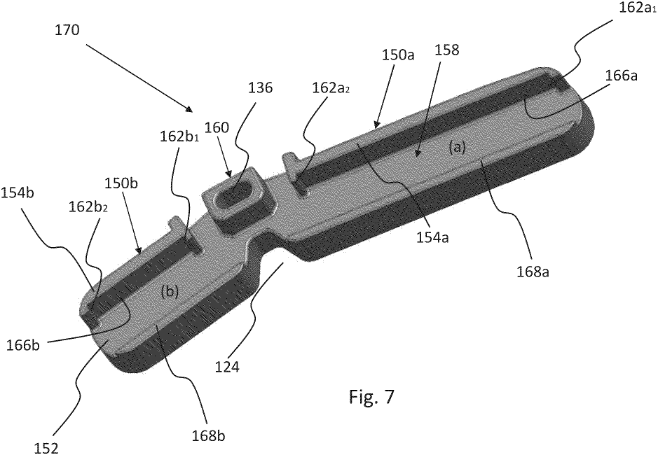

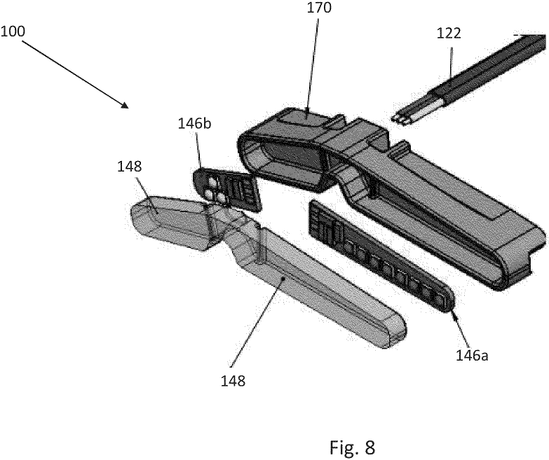

The casing 170 of display 100 is shown in FIGS. 5, 6, and 7. The figures show the right-side display 170R, while the left-side display (not shown) is mirrored. FIG. 5 shows the casing in a front-perspective view, while FIGS. 6 and 7 show the casing 170 in rear-perspective views. The casing 170 is an integral unit which is made of flexible material, such as silicon. As noted, the casing 170 is designed to provide adaptation to mirrors whose periphery has various dimensions and shapes. This adaptationcharacteristic maintains even when rigid components, such as rigid printed boards 146a and 146b (FIG. 8), are used. Back to FIG. 5, in the depth axis D, the casing is divided into two integral portions, a front portion 132, and a rear portion 152, that are separated by a partition wall 158. Partition wall 158, together with peripheral extension 134, define a two-sections (150a, 150b) container 180 for accommodating the two (or more) printed boards 146a and 146b (shown in FIG. 8), respectively.

Display 100 is adhesively attached to the top frame 116 (FIG. 3) of the mirror, either directly or by means of a two-sided adhesive layer. The figures depict a design for the latter alternative. The rear portion 152 (FIG. 5) has two recesses. Each recess is designed to accommodate a flexible two-side adhesive layer (not shown). The recess of the (a) side includes an upper surface 166a facing down (best shown in FIG. 7) within first top protrusion 154a, and is limited by the two place-holders 162a₁ and 162a₂, while the recess of the (b) side includes an upper surface 166b facing down within second top protrusion 154b, and is limited by the two place-holders 162b₁ and 162b₂. Each place-holder 162 protrudes downward typically 1 mm, from the level of the respective upper surface 166, depending on the depth of the two-side adhesive layer which is used. Alternatively, the display may not include said place-holders 162, if a conventional adhesive (in alternative to the two-sided adhesive layer) is used to attach the display 100 to the frame 116 of mirror 140 (FIG. 3). The width of surface 166 (FIG. 7) is typically between 4 mm and 5 mm (however, in some cases the width may be up to 10 mm), to adapt the most common depth of the mirror’s frame 116. The width of surface 166 may be slightly shorter than the depth of frame 116 (FIG. 3), or slightly longer. Casing 170 (FIGS. 5, 6, and 7) may also have at its rear side two bottom protrusions, 168a and 168b (FIG. 7), respectively. The protruding level of each bottom protrusion 168 is smaller than the width of the upper surface 166. While the upper surface 166 covers a part or the entire width of frame 116 of the mirror, bottom protrusions 168 remain at the front side of mirror 140, as shown in FIG. 3, and their upper surfaces 147a and 147b (FIG. 6), may be in contact with the bottom surface 126 of frame 116 (FIG. 3), to provide additional strength and support to the attachment of display 100 to mirror 140.

Upper surface 166 (FIG. 7) is only one example of an attachment surface between display 100 and the vehicle’s mirror. The location of the (one or more) attachment surfaces may vary. In another embodiment, the attachment surface is one or more external surfaces at one or more bottom walls of the casing. In still another embodiment, the attachment surface is one or more external surfaces on one or more top walls of the casing. As said, more than one attachment surface may be provided at one or more of the casing’s locations mentioned above to provide a variety of attachment possibilities to the user.

During the installation of display 100 on top of mirror 140 (FIG. 3), the two upper surfaces 166 at the back portion of the display are bent to conform with the contour of the top frame 116 of the mirror and are adhesively attached to the top frame 116 utilizing the two-sided adhesive layers (not shown), or by using a direct-adhesive attachment. The bending of the two surfaces 166 (FIG. 7) is substantially independent of the fact that solid components (such as the printed boards 146a and 146b (FIG. 8)) are or are not included within the two-sections container 180 (FIG. 5). More specifically, the possibly rigid contents of the two-section container 180 substantially “float” relative to the outlines of upper surfaces 166 (FIG. 7), when these surfaces are attached to the top frame 116 of mirror 140. This “floating” characteristic is an important feature of the invention, as it enables the attachment of the add-on display 100 to a top of mirror 140 substantially having any contour and irrespective of the existence of solid contents within the two-sections of front container 180. The first opening 124 between any two adjacent sections 150 (FIG. 5) of the display further adds to the display’s flexibility of adaptation to the mirror’s top contour and to the secured attachment. The fact that the signal cable 122 enters once at a connecting piece 160 (between any two longitudinal sections 150a and 150b) does not reduce this attachment flexibility (FIG. 3).

As shown in FIG. 3, an important feature of the invention is the fact that only the hight of the top protrusion 154 (FIG. 5) (typically less than 10 mm) adds to the height of the original side-mirror 140, and in fact, only this relatively small additional height of the add-on device faces the front wind. Most of the height of the elongated casing (namely, typically 6 mm) is positioned below the top level of the frame of the mirror. Therefore, in such a manner a very small portion of the casing is exposed to a front wind, and once the casing is adhesively attached, the chance for separation of the casing from the mirror due to front winds is very low. Moreover, the device occupies at most 1-2 mm from the active height of the mirror (typically about 1% from the entire active height of the mirror).

FIG. 8 shows in exploded view the main components of each display 100. The display basically includes: casing 170, two printing boards 146a and 146b, each containing a sequence of lights 112 and 114, respectively (FIG. 4), a transparent front window 148, and a signal cable 122, which enters into second opening 136 (FIG. 7) at casing 170.

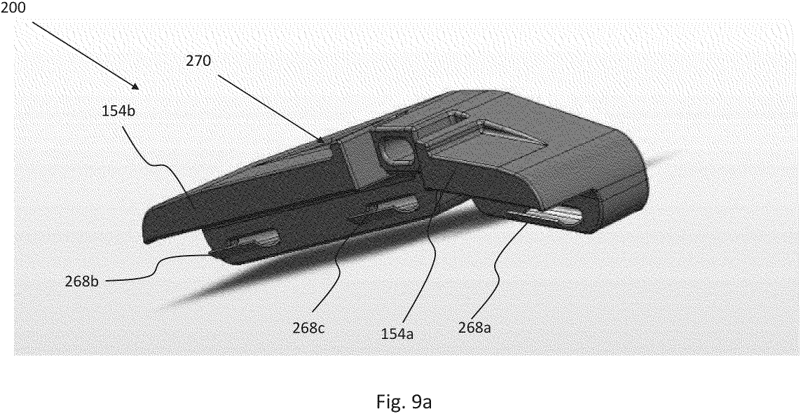

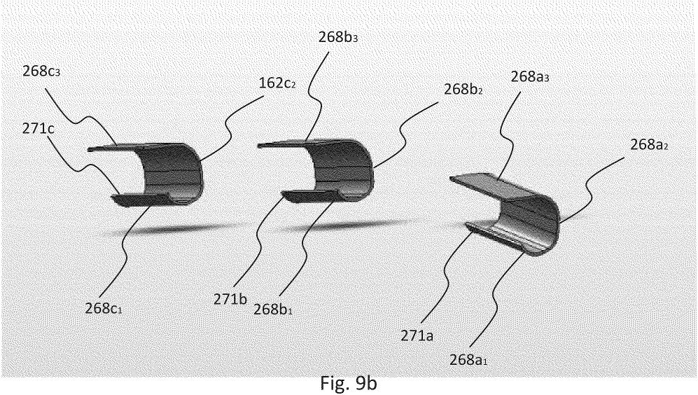

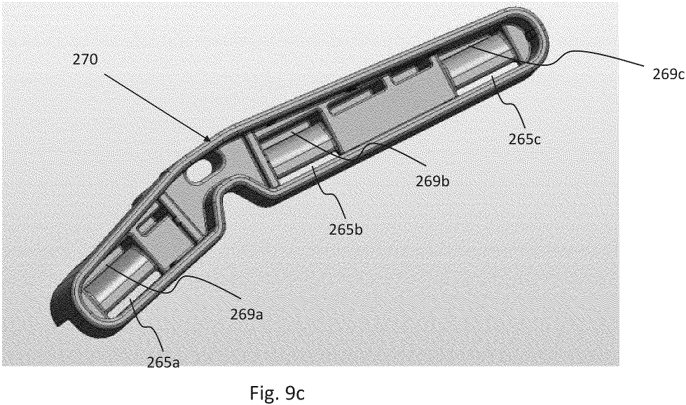

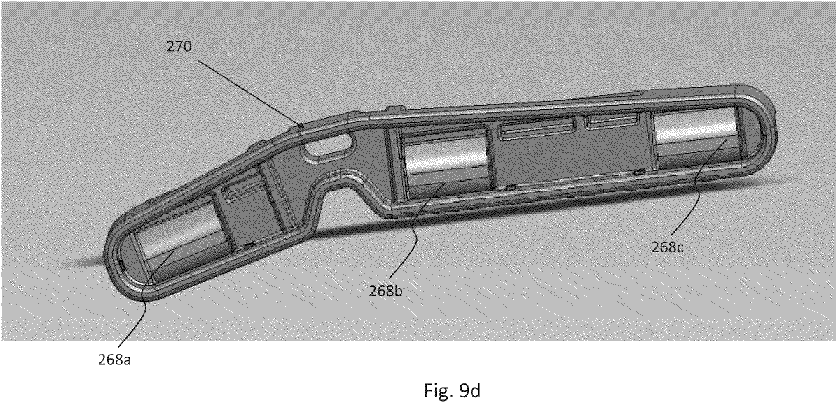

FIGS. 9a-9d show a display 200, according to another embodiment of the invention. The display 200 differs from display 100 by the type of contact and attachment to the front of mirror 140, namely, by including one or more (in this specific case, three) flexible elements 268 that replace the bottom protrusions 168a and 168b (FIG. 7) of display 100. As best shown in FIG. 9b, each of the three flexible elements 268a, 268b, and 268c is a flat-bended strip, having substantially three sections: lower section 268x₁, middle section 268x₂, and upper section 268x₃ (index x represents one of the a, b, or c strips, respectively). While the lower section x₁ of each flexible element 268 is curved and protrudes out of the casing 270 via a respective opening 265x (see FIG. 9c), the other two sections, namely, middle section x₂ and upper section x₃, are maintained within casing 270, as shown in FIG. 9d. More specifically, while each of the middle sections is held substantially vertically within casing 270, each of the upper sections x₃ is held substantially horizontal within a respective cavity 269 (FIG. 9c), in top protrusions 154 (FIG. 9a). In some cases, the upper and middle sections x₂ and x₃ may be adhesively attached to casing 270. In other cases, the rear facets of printed boards 146a and 146b (FIG. 8) provide this attachment. The rest of the structure of display 200 is substantially the same, mutatis mutandis, as the structure of display 100. In some other cases, the portions of the elastic elements within the front sections of the casing may have another shape, while considering that this shape has no functionality with respect to the interaction with the mirror.

When installed, the edge 271 of section x1 of each flexible element 268 (see FIG. 9b), respectively, comes into a contact with the bottom surface 126 of the frame 116 of mirror 140 (see FIG. 3). This form of attachment has more strength and better adaptation to various contours of mirrors frames, thanks to the flexibility of element 268. The improved strength and adaptation are essential, as the display has to sustain significant wind forces and vibrations during the motorcycle’s driving. The shape of each of the flexible elements 268 and how they are held within casing 270 is only one example. Other shapes for providing bottom contact with bottom 126 of frame 116 are suitable.

While some embodiments of the invention have been described by way of illustration, it will be apparent that the invention can be carried into practice with many modifications, variations, and adaptations, and with the use of numerous equivalent or alternative solutions that are within the scope of persons skilled in the art, without departing from the spirit of the invention or exceeding the scope of the claims.

1. An add-on display configured for attachment to a contour frame of a side-mirror of a vehicle and to provide visual awareness, safety or alert signals, comprising at least partially flexible casing, said casing comprising:
a. a partition wall separating between a front portion and a rear portion of the casing;
b. said front portion comprising one or more sections along a longitudinal axis of the casing, at least one of the sections is configured to contain at least one Light Emitting Diodes (LEDs) that issues said visual signals;
c. a connecting piece in between any two adjacent sections, if more than one exists, said connecting piece comprising at least a first opening at its bottom; and
d. at least one attachment surface configured for attachment to a surface of said contour frame the side-mirror of the vehicle.

2. The add-on display of claim 1, wherein said first opening has an upside-down V-shape in cross-section;.

3. The add-on display of claim 1, wherein each said attachment surface is longitudinally disposed at the rear portion and faces down.

4. The add-on display of claim 3, wherein each said attachment surface facing down is located at a top protrusion verticcally protruding from said partition wall.

5. The add-on display of claim 3 comprising one or more recesses at each said attachment surfaces, each recess being defined by a respective upper surface, and two side-protrusions.

6. The add-on display of claim 5, wherein each of said recesses is configured to contain a two-side adhesive layer.

7. The add-on display of claim 1, wherein said flexible casing is formed as one integral unit.

8. The add-on display of claim 1, wherein a multi-section container is defined at said front portion by said partition wall and a peripheral extension protruding therefrom.

9. The add-on display of claim 1, wherein at least one of said Light Emitting Diodes are positioned on a printed board which is configured to issue each said visual signals based on a respectively received external signal.

10. The add-on display of claim 1, wherein a sequence of Light Emitting Diodes (LEDs) are positioned on each said printed board.

11. (canceled)

12. The add-on display of claim 1, wherein said casing is made of a flexible silicon.

13. The add-on display of claim 1, further comprising a second opening at said connecting piece, said second opening is configured to allow passage of a signal cable.

14. The add-on display of claim 13, further comprising a guiding element configured for attaching said signal cable to a rear or rear-top surface of the side-mirror.

15. (canceled)

16. The add-on display of claim 4, further comprising one or more longitudinal bottom protrusions at said rear portion, each said bottom protrusion protrudes from said partition wall a width which is smaller than the width of said top protrision.

17. The add-on display of claim 8, further comprising a transparent window for sealing said multi-section container.

18. The add-on display of claim 1, wherein an outline of a top wall of the connecting piece is bended-down at an angle with respect to an outline of a top wall of a first of said sections, and an outline of a top wall of a second of said sections is further bended-down at an angle with respect to the outline of said top wall of the connecting piece.

19. (canceled)

20. The add-on display of claim 1, further comprising one or more bottom elastic elements that are at least partially protrude outwards through the partition wall, and are configured to provide front attachment of the display to a bottom edge of the frame of the side-mirror of the vehicle.

21. The add-on display of claim 20, wherein each of the bottom elastic elements has a shape of an elastic bended strip.

22. The add-on display of claim 20, wherein a first section of each elastic element protruds outwards through a respective opening at the partition wall, and a second section of each said elastic element is contained within the front portion of the display.

23. The add-on display of claim 22, wherein a third section of each of said elastic elements is containd at a cavity within a top protrusion verticcally protruding from said partition wall.
